(19) United States
(12) Patent Application Publication
(10) Pub. No.: US 2016/0288308 A1
(43) Pub. Date: Oct. 6, 2016

(54) Protective Device at least for Protecting a User in the Event of an Uncontrolled Blockage of a Portable Power Tool

(71) Applicant: Robert Bosch GmbH, Stuttgart (DE)

(72) Inventors: Axel Kuhnle, Freiberg A. N. (DE); Lars Schmid, Nuertingen (DE); Carsten Diem, Ludwigsburg (DE)

(21) Appl. No.: 15/083,026

(22) Filed: Mar. 28, 2016

(30) Foreign Application Priority Data
Mar. 30, 2015 (DE) 10 2015 205 689.9

(51) Int. Cl. B25D 16/00; B25D 11/06

(52) U.S. Cl. CPC B25D 16/003; B25D 11/06; B25D 2216/0046; B25D 2250/165; B25D 2250/371

(57) ABSTRACT

A protective device at least for protecting a user in the event of an uncontrolled blockage of a portable power tool includes at least one rotationally drivable shaft and at least one wrap-spring-free overload clutch unit which is arranged on the shaft and is configured at least to interrupt transmission of a drive force if a torque limit is exceeded. The protective device further including at least one wrap-spring clutch unit configured to brake the shaft.

This application claims priority under 35 U.S.C. §119 to patent application no. DE 10 2015 205 689.9, filed on Mar. 30, 2015 in Germany, the disclosure of which is incorporated herein by reference in its entirety.

### BACKGROUND

A protective device at least for protecting a user in the event of an uncontrolled blockage of a portable power tool is already known from DE 195 40 718 B4, wherein the protective device comprises at least one rotationally drivable shaft and at least one wrap-spring-free overload clutch unit which is arranged on the shaft and is intended to interrupt transmission of a drive force if a torque limit is exceeded.

### SUMMARY

The disclosure proceeds from a protective device, in particular from a blockage protective device, at least for protecting a user in the event of an uncontrolled blockage of a portable power tool, having at least one rotationally drivable shaft and having at least one wrap-spring-free overload clutch unit which is arranged on the shaft and is intended at least to interrupt transmission of a drive force if a torque limit is exceeded.

It is proposed that the protective device comprises at least one wrap-spring clutch unit which is intended to brake the shaft, in particular to a standstill. Preferably, the wrap-spring clutch unit is intended to brake the shaft to a standstill in the event of an uncontrolled blockage. The term “intended” should be understood as meaning in particular specially designed and/or specially equipped. The fact that an element and/or a unit is intended for a particular function should be understood as meaning in particular that the element and/or the unit fulfill(s) and/or execute(s) this particular function in at least one use state and/or operating state. An “uncontrolled blockage of a portable power tool” should be understood here as meaning in particular sudden blocking of an application tool, arranged in a tool receptacle of the portable power tool, as a result of the application tool catching in a workpiece. In the event of such a blockage, there is the risk of injury to a user or persons located in the vicinity of the portable power tool, since the portable power tool can rotate in particular in an uncontrolled manner about a drive axis of the portable power tool in the event of such a blockage as a result of a force of a drive unit of the portable power tool.

A “wrap-spring clutch unit” should be understood here as meaning in particular a unit which comprises at least one wrap-spring element which is intended, depending on a wound state of the wrap-spring element, at least to connect at least two elements by means of a force-fitting connection or to interrupt a connection between the at least two elements. In order to connect the at least two elements, the wrap-spring element can bear against outer surfaces of the at least two elements, against inner surfaces of the at least two elements or against an outer surface of one of the at least two elements and against an inner surface of one of the at least two elements. Preferably, the wrap-spring clutch unit is intended to brake the rotationally drivable shaft by way of a force-fitting connection to a fixed element, in particular a bearing flange of the protective device. The wrap-spring clutch unit can be arranged at different positions, in particular at different positions on the portable power tool, for example at least partially on the shaft, in a transmission stage upstream or downstream of the shaft, viewed in an overall direction of action of the drive force of a drive train upstream or downstream of the shaft or at some other position that appears appropriate to a person skilled in the art within the portable power tool.

The overload clutch unit is preferably intended at least to interrupt a force flow between the shaft, in particular a pinion shaft intended to drive the tool receptacle in rotation, and the drive unit when a torque limit is exceeded. A triggering mechanism of the overload clutch unit can be configured mechanically or in a sensor-controlled manner. In a mechanical configuration of the triggering mechanism of the overload clutch unit, an interruption of a drive force is triggered in a manner already known to a person skilled in the art as a result of the exceeding of a retaining force between at least two elements of the overload clutch unit that cooperate in a form-fitting and/or force-fitting manner. In a sensor-controlled configuration of the triggering mechanism of the overload clutch unit, an interruption of a drive force is triggered in a manner already known to a person skilled in the art as a result of at least one sensor signal. Preferably, the triggering mechanism of the overload clutch unit is configured in a mechanical manner. The term “wrap-spring-free” should be understood here as meaning in particular a configuration of a unit, in particular the overload clutch unit, that is uncoupled from a wrap-spring element. The overload clutch unit preferably does not comprise a wrap-spring element. Preferably, the overload clutch unit is integrated in at least one transmission element, in particular a gear, of a transmission unit of the portable power tool. A triggering mechanism for the protective device in the event of an uncontrolled blockage of the portable power tool can be configured in a mechanical or sensor-controlled manner in a manner already known to a person skilled in the art.

By means of the configuration according to the disclosure of the protective device, high user safety can advantageously be achieved, since the portable power tool can be braked safely, and in particular stopped safely, after passing through a small rotation angle if an uncontrolled blockage occurs. Rotation energy of the portable power tool can advantageously be converted into thermal energy by braking of the shaft, in order to advantageously keep a possible rotation angle of the portable power tool small if an uncontrolled blockage occurs. Furthermore, safe braking of the shaft can advantageously be allowed, wherein the momentum of an, in particular running-down, drive unit of the portable power tool is advantageously able to be dissipated via the overload clutch unit.

It is furthermore proposed that the wrap-spring clutch unit comprises at least one driver element connected to a free end of the shaft, and at least one wrap-spring element, wherein the wrap-spring element cooperates with the driver element in order to brake the shaft. Preferably, the free end of the shaft is remote from an end of the shaft at which the overload clutch unit and/or a drive-force transmission region, in particular a toothing of the shaft, is/are arranged on the shaft. Preferably, at least one end of the wrap-spring element is fixed to the driver element. Preferably, the driver element is intended to trigger a winding movement, in particular winding up and/or unwinding, of the wrap-spring element and/or to transmit a brake force to the shaft. In particular, in at least one exemplary embodiment of the protective device, at least one surface of the driver element is configured as a brake surface which cooperates in particular with the wrap-spring element. By means of the configuration according to the disclosure, protection of the shaft can advantageously be achieved, since an action of brake forces on the shaft is realizable via the driver element. In addition, advantageously brake abrasion on a shaft surface of the shaft can advantageously be prevented.

Furthermore, it is proposed that the driver element is connected to the shaft for conjoint rotation. The expression “connected for conjoint rotation” should be understood as meaning in particular a connection of at least two elements which, via at least one complete revolution of the at least two elements, transmits on average a power flow with an unchanged torque, an unchanged direction of rotation and/or an unchanged speed. The driver element, in particular in at least one state of the protective device, can be connected to the shaft for conjoint rotation by means of a force-fitting, form-fitting and/or cohesive connection. Preferably, the driver element is connected to the shaft for conjoint rotation, and in particular fixed to the shaft, by means of a screw connection, by means of a press-fit connection or by means of the wrap-spring element. However, it is also conceivable for the driver element to be connected to the shaft for conjoint rotation by means of some other element that appears appropriate to a person skilled in the art or by means of some other manner of connection that appears appropriate to a person skilled in the art, for example by means of a riveted connection, by means of a welded connection, by means of an adhesive bond, by means of a latching connection, or the like. By means of the configuration according to the disclosure, reliable braking of the shaft can advantageously be achieved by braking of the driver element. In addition, gentle braking of the shaft can advantageously be realized, since brake forces act primarily on the driver element and are transmissible to the shaft as a result of the connection for conjoint rotation between the shaft and the driver element.

In addition, it is proposed that the wrap-spring clutch unit comprises at least one activation unit which has at least one movably mounted activation element which is intended to bring about a winding movement, in particular winding up and/or unwinding, of the wrap-spring element of the wrap-spring clutch unit as a result of a relative movement, in particular a relative movement relative to the shaft and/or to a bearing flange of the protective device. The activation element can be a separate actuating sleeve, a separate brake disk, the driver element or the like. Preferably, the activation element is mounted in a rotatable or twistable manner, in particular relative to the shaft and/or to the bearing flange of the protective device. Preferably, the activation unit comprises at least one actuator which is intended to move the activation element and/or to hold it in position. Preferably, the actuator is configured as a magnetic element, in particular as an electromagnet. However, it is also conceivable for the actuator to have some other configuration that appears appropriate to a person skilled in the art, for example a configuration as a spring element, as an electric motor, as a linear drive element, or the like. By means of the configuration according to the disclosure, reliable activation of the wrap-spring clutch unit can advantageously be achieved. Particularly preferably, the activation element is able to be held in an enabling position in which the wrap-spring element enables rotation of the shaft, by means of an electromagnet. An energy-supply-independent function of the wrap-spring clutch unit can particularly advantageously be achieved, since when energization of the electromagnet stops, automatic winding and thus braking of the shaft and/or of the driver element by the wrap-spring element can be achieved.

Furthermore, it is proposed that, in particular in at least one exemplary embodiment, the wrap-spring clutch unit comprises at least one activation unit which has at least one movably mounted activation element that is mounted so as to be twistable through an angle of less than 360°. The activation element is configured preferably as a sleeve, in particular as an actuating sleeve. Preferably, the activation element surrounds the shaft at least partially, in particular when viewed in a direction of rotation of the shaft. In particular, the activation element is mounted so as to be twistable through an angle of less than 270°, preferably less than 180°and particularly preferably through an angle of less than 90°, in particular relative to the shaft and/or relative to the bearing flange of the protective device. Preferably, at least one end of the wrap-spring element is fixed to the activation element. By means of the configuration according to the disclosure, it is advantageously possible to achieve a compact protective device which advantageously requires little installation space. In addition, an activation unit that is simple to implement in design terms can advantageously be realized.

It is furthermore proposed that, in particular in at least one exemplary embodiment, the protective device comprises at least one bearing flange on which the shaft is rotatably mounted, wherein the wrap-spring clutch unit has at least one wrap-spring element which bears against the bearing flange at least during a rotational movement of the shaft and is not in contact with the shaft or with a driver element, arranged on the shaft, of the wrap-spring clutch unit. Preferably, in at least one rotation-enabling position, as viewed in a direction extending at least substantially perpendicularly to a rotation axis of the shaft, the wrap-spring element is at a distance from the shaft and/or from the driver element which is in particular greater than 0.01 mm, preferably greater than 0.1 mm and particularly preferably greater than 1 mm, in particular when viewed in a coil region of the wrap-spring element which is free of a fixing region of the wrap-spring element, by means of which the wrap-spring element is fixable to an element. In a rotation-enabling position of the wrap-spring element, a free rotational movement of the shaft is advantageously possible. In a braking position of the wrap-spring element, the shaft is brakable preferably by an action of the wrap-spring element, since in particular the wrap-spring element bears against the shaft and/or against the driver element. Preferably, the protective device has at least one bearing element, in particular a rolling bearing element, which is arranged at the bearing flange. Preferably, the shaft is mounted on the bearing flange in a rotational manner by means of the bearing element. By means of the configuration according to the disclosure, a free rotation in a nonbraked state of the shaft can be realized in a simple manner in design terms. In addition, a force-fitting connection between the bearing flange and the shaft and/or the bearing flange and the driver element in order to brake the shaft can advantageously be realized.

In addition, it is proposed that, in particular in at least one exemplary embodiment, one end of the wrap-spring element is fixed to the bearing flange and another end is fixed to an activation element of an activation unit of the wrap-spring clutch unit, said activation element being twistable through less than 360°. Preferably, the wrap-spring element has at least one fixing protrusion in each case at the end and at the other end. The fixing protrusions extend preferably tangentially to an outer circumference of the wrap-spring element, at least substantially transversely to the rotation axis of the shaft and/or at least substantially parallel to the rotation axis of the shaft. By means of the configuration according to the disclosure, it is advantageously possible to achieve a compact activation unit which allows a reliable braking function of the wrap-spring clutch unit.

Furthermore, it is proposed that, in particular in at least one exemplary embodiment, the wrap-spring clutch unit comprises at least one wrap-spring element, one end of which is fixed to a driver element of the wrap-spring clutch unit, said driver element being connected to the shaft for conjoint rotation, and the other end of which is fixed to a rotatably mounted activation element of an activation unit of the wrap-spring clutch unit. Preferably, the driver element or an element of the activation unit that cooperates with a magnetic element of the activation unit forms the activation element. The activation element is preferably mounted so as to be rotatable through more than 360°, in particular mounted so as to be rotationally movable. The activation element is preferably formed from a magnetizable material, in particular a ferritic material. Preferably, in at least one rotation-enabling position, as viewed in a direction extending at least substantially perpendicularly to a rotation axis of the shaft, the wrap-spring element is at a distance from the bearing flange which is in particular greater than 0.01 mm, preferably greater than 0.1 mm and particularly preferably greater than 1 mm. By means of the configuration according to the disclosure, a particularly advantageous winding movement along an overall extent of the wrap-spring element can be achieved.

It is furthermore proposed that, in particular in at least one exemplary embodiment, the protective device comprises at least one bearing flange on which the shaft is rotatably mounted, wherein the activation unit has at least one magnetic element which is intended to produce a force fit between the bearing flange and the wrap-spring element as a result of a rotational movement of the activation element being braked. The magnetic element can be configured as a permanent magnet or as an electromagnet. In a configuration of the magnetic element as a permanent magnet, an action of a magnetic force on the activation element can be activated for example as a result of a relative movement of the magnetic element relative to the bearing flange. In a configuration of the magnetic element as an electromagnet, an action of a magnetic force on the activation element can be activated for example in dependence on a sensor signal and/or on an electrical switch signal. By means of the configuration according to the disclosure, advantageous controllability of activation of the wrap-spring clutch unit can be realized.

In addition, it is proposed that, in particular in at least one exemplary embodiment, the wrap-spring clutch unit comprises at least one wrap-spring element which has two different coil diameters. Preferably, the wrap-spring element has an abrupt change in coil diameter. Preferably, a coil diameter of the wrap-spring element is adapted to an outside diameter of a subregion of the bearing flange and a further coil diameter of the wrap-spring element is adapted to an outside diameter of the driver element. Different coil diameters of the wrap-spring element can be for example production-related or assembly-related. In the case of different coil diameters which are assembly-related, it is conceivable for the wrap-spring element to be pressed, in the region of at least one component, into at least one groove in the component, in particular in the driver element. In the case of different coil diameters which are production-related, it is conceivable for the wrap-spring element to already have at least two different coil diameters as a result of production. By means of the configuration according to the disclosure, precise guidance of the wrap-spring element can advantageously be achieved. In addition, a tendency of the wrap-spring element to roll can advantageously be kept low.

Furthermore, it is proposed that, in particular in at least one exemplary embodiment, the wrap-spring clutch unit comprises at least one wrap-spring element which is surrounded at least partially by the shaft. Preferably, the shaft has an inner cutout which has a maximum internal dimension, in particular inside diameter, that is smaller than a maximum external dimension, in particular outside diameter, of the wrap-spring element in an unloaded, in particular relaxed, state of the wrap-spring element. By means of the configuration according to the disclosure, a compact wrap-spring clutch unit can advantageously be achieved. In addition, the wrap-spring element can advantageously be guided in the shaft.

It is furthermore proposed that, in particular in at least one exemplary embodiment, the shaft has an internal cutout in which the wrap-spring element is fixed at least by one end. The wrap-spring element is preferably fixed in the shaft by means of a force-fitting connection. However, it is also conceivable for the wrap-spring element to be fixed to the shaft by means of some other manner of connection that appears appropriate to a person skilled in the art, for example by means of a force-fitting and/or cohesive connection (by means of a welded connection, by means of a riveted connection, by means of a latching connection, or the like). By means of the configuration according to the disclosure, a reliable brake-force action on the shaft can advantageously be achieved.

In addition, it is proposed that, in particular in at least one exemplary embodiment, the protective device comprises at least one bearing flange on which the shaft is rotatably mounted, wherein the wrap-spring element extends through a cutout in the bearing flange. The cutout in the bearing flange preferably has a maximum internal dimension which is greater than a maximum external dimension, in particular outside diameter, of the wrap-spring element in an unloaded, in particular relaxed, state of the wrap-spring element. By means of the configuration according to the disclosure, it is advantageously possible for the wrap-spring element to bear extensively against an inner wall, delimiting the cutout, of the bearing flange in order to brake the shaft.

Furthermore, it is proposed that the wrap-spring clutch unit is arranged at an end of the shaft which is remote from a further end of the shaft at which the overload clutch unit is arranged. The overload clutch unit is preferably arranged at an end of the shaft at which a drive-force transmission region, in particular a toothing of the shaft, is arranged on the shaft. Particularly preferably, the overload clutch unit is integrated in a spur gear, arranged on the shaft, of the transmission unit of the portable power tool. By means of the configuration according to the disclosure, appropriate use can advantageously be made of installation space that is already present.

A portable power tool, in particular a hammer drill or a hammer drill and chipping hammer, having at least one percussion mechanism unit and having at least one protective device according to the disclosure is furthermore proposed. A “portable power tool” should be understood here as meaning in particular a power tool for machining workpieces, it being possible for said power tool to be transported by a user without a transport machine. The portable power tool has in particular a mass which is less than 40 kg, preferably less than 10 kg and particularly preferably less than 5 kg. Particularly preferably, the portable power tool has a mass which corresponds to a value in a range of values from 4 kg to 13 kg. Preferably, the portable power tool is configured as a hammer drill or a hammer drill and chipping hammer. However, it is also conceivable for the portable power tool to have some other configuration that appears appropriate to a person skilled in the art, for example a configuration as a percussion drilling machine, as a screwdriver, as a drilling machine, as a gardening machine, as a planing machine, as a circular saw machine, or the like. By means of the configuration according to the disclosure, a high safety factor for a user of the portable power tool can particularly advantageously be realized. A user can particularly advantageously be protected from injury in the event of an uncontrolled blockage.

The protective device according to the disclosure and/or the portable power tool according to the disclosure should not in this case be limited to the above-described application and embodiment. In particular, the protective device according to the disclosure and/or the portable power tool according to the disclosure can have a number of individual elements, components and units which differs from the number mentioned herein in order to fulfill a functionality described herein. In addition, the ranges of values specified in this disclosure and values lying within said limits should be considered to be disclosed and able to be used in any desired manner.

### BRIEF DESCRIPTION OF THE DRAWINGS

Further advantages can be gathered from the following description of the drawings. The drawings illustrate exemplary embodiments of the disclosure. The drawings, the description and the claims contain numerous features in combination. A person skilled in the art will also expediently consider the features individually and combine them into appropriate further combinations.

In the drawings:

FIG. 1 shows a portable power tool according to the disclosure having at least one percussion mechanism unit and having at least one protective device according to the disclosure in a schematic illustration,

FIG. 2 shows a sectional view of the protective device according to the disclosure in a schematic illustration,

FIG. 3 shows a plan view of the protective device according to the disclosure in a schematic illustration,

FIG. 4 shows a sectional view of a first alternative protective device according to the disclosure in a schematic illustration,

FIG. 5 shows a sectional view of a second alternative protective device according to the disclosure in a schematic illustration, and

FIG. 6 shows a sectional view of a third alternative protective device according to the disclosure in a schematic illustration.

### DETAILED DESCRIPTION

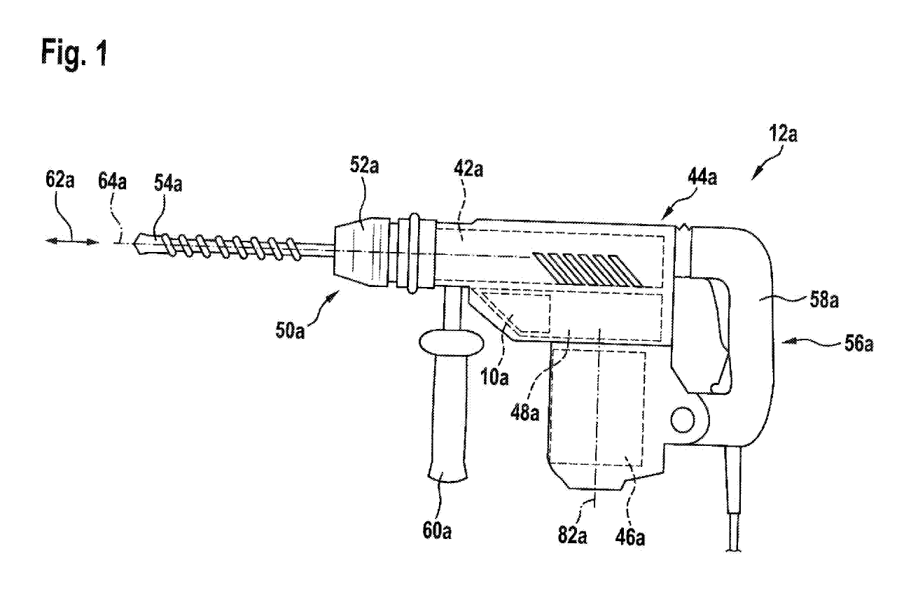

FIG. 1 shows a portable power tool 12a having at least one percussion mechanism unit 42a and having at least one protective device 10a. The portable power tool 12a is configured as a hammer drill or as a hammer drill and chipping hammer. The portable power tool 12a comprises a housing unit 44a at least for receiving the percussion mechanism unit 42a and the protective device 10a. Furthermore, the portable power tool 12a has at least one drive unit 46a and at least one transmission unit 48a. The drive unit 46a and the transmission unit 48a are arranged in the housing unit 44a. In addition, the portable power tool 12a comprises, in a front region 50a, a tool receptacle 52a for receiving an application tool 54a. On a side 56a remote from the front region 50a, the portable power tool 12a comprises a main handle 58a for guiding the portable power tool 12a and for transmitting a force from a user to the portable power tool 12a. The portable power tool 12a is embodied with a detachable auxiliary handle 60a. The auxiliary handle 60a can be fastened detachably to the portable power tool 12a via a latching connection or other connections that appear appropriate to a person skilled in the art. The auxiliary handle 60a is arranged on the portable power tool 12a in the vicinity of the tool receptacle 52a in order for the portable power tool 12a to be guided by the user. A main extension direction 62a of the portable power tool 12a extends from the main handle 58a in the direction of the tool receptacle 52a. The main extension direction 62a extends at least substantially parallel to a rotation axis 64a of the tool receptacle 52a. In order to generate a drive torque and to generate a percussive pulse by way of the percussion mechanism unit 42a, the portable power tool 12a has the drive unit 46a. The drive torque of the drive unit 46a is transmissible to the percussion mechanism unit 42a via the transmission unit 48a and/or the protective device 10a in order to generate the percussive pulse. The percussive pulse of the percussion mechanism unit 42a is able to be generated in a manner known to a person skilled in the art. A movement axis of a percussion element (not illustrated in more detail here), in particular a piston, a striker or an anvil, of the percussion mechanism unit 42a extends at least substantially parallel to the rotation axis 64a of the tool receptacle 52a. Furthermore, via the transmission unit 48a and/or via the protective device 10a, the drive torque is transmissible to the tool receptacle 52a in order to generate a rotational movement of the tool receptacle 52a via a hammer tube (not illustrated in more detail here) of the percussion mechanism unit 42a.

FIG. 2 shows a sectional view of the protective device 10a. The protective device 10a is intended at least to protect a user in the event of an uncontrolled blockage of the portable power tool 12a. The protective device 10a comprises at least one rotationally drivable shaft 14a and at least one wrap-spring-free overload clutch unit 16a which is arranged on the shaft 14a and is intended to interrupt transmission of a drive force if a torque limit is exceeded. The shaft 14a is preferably configured as a pinion shaft. The shaft 14a comprises at least one drive-force transmission region 66a. The drive-force transmission region 66a is connected to the shaft 14a for conjoint rotation. In particular, the drive-force transmission region 66a is configured in one piece with the shaft 14a. The drive-force transmission region 66a is configured as a gear. The drive-force transmission region 66a is intended to mesh with a gear element (not illustrated in more detail here), arranged on the hammer tube, of the percussion mechanism unit 42a. The hammer tube is drivable in rotation by the shaft 14a, in a manner already known to a person skilled in the art, in at least one operating state, in particular in a hammer-drill operating state. The overload clutch unit 16a is arranged on the shaft 14a at least substantially in a manner adjoining the drive-force transmission region 66a. The overload clutch unit 16a is integrated in a gear 68a, in particular in a spur gear, of the transmission unit 48a and/or of the protective device 10a. The gear 68a is mounted rotatably on the shaft 14a. The gear 68a preferably engages in a drive shaft, in particular an armature shaft (not illustrated in more detail here), of the drive unit 46a. A connection for conjoint rotation of the gear 68a and the shaft 14a is producible by means of the overload clutch unit 16a.

The overload clutch unit 16a comprises at least one movably mounted form-fitting and/or force-fitting element 70a which is intended to cooperate in a form-fitting and/or force-fitting manner with the gear 68a, in particular with an inner wall, facing the form-fitting and/or force-fitting element 70a, of the gear 68a. The form-fitting and/or force-fitting element 70a is movably mounted in a torque transmission element 84a of the overload clutch unit 16a. The torque transmission element 84a is connected to the shaft 14a for conjoint rotation. A movement axis of the form-fitting and/or force-fitting element 70a extends at least substantially perpendicularly to a rotation axis 72a of the shaft 14a. The rotation axis 72a of the shaft 14a extends preferably at least substantially transversely, in particular perpendicularly, to the rotation axis 64a of the tool receptacle 52a and/or to the movement axis of the percussion mechanism element of the percussion mechanism unit 42a. The rotation axis 72a of the shaft 14a extends in particular at least substantially parallel to a drive axis 82a of the drive unit 46a.

The overload clutch unit 16a furthermore comprises at least one spring element 74a which is intended to subject the form-fitting and/or force-fitting element 70a to a spring force in the direction of the gear 68a. The form-fitting and/or force-fitting element 70a is able to be pressed against the gear 68a by means of the spring element 74a in order to produce a holding force between the gear 68a and the torque transmission element 84a. If a torque acting on the gear 68a, and thus a force resulting therefrom, exceeds the holding force between the gear 68a and the form-fitting and/or force-fitting element 70a, transmission of a drive force is interrupted in particular in a manner already known to a person skilled in the art. It is conceivable for the overload clutch unit 16a to have a multiplicity of form-fitting and/or force-fitting elements 70a and/or a multiplicity of spring elements 74a which are intended to allow a drive force to be interrupted, in a manner already known to a person skilled in the art, if a torque limit is exceeded.

Furthermore, the protective device 10a comprises at least one wrap-spring clutch unit 18a, which is intended to brake the shaft 14a. The wrap-spring clutch unit 18a is arranged at an end of the shaft 14a that is remote from a further end of the shaft 14a at which the overload clutch unit 16a is arranged. The wrap-spring clutch unit 18a comprises at least one driver element 20a connected to a free end of the shaft 14a, and at least one wrap-spring element 22a, wherein the wrap-spring element 22a cooperates with the driver element 20a in order to brake the shaft 14a. The free end of the shaft 14a is that end of the shaft 14a that is remote from the overload clutch unit 16a. The driver element 20a is connected to the shaft 14a for conjoint rotation. The driver element 20a can be connected to the shaft 14a for conjoint rotation by means of a screw connection, by means of a press-fit connection, by means of an adhesive or welded connection or some other manner of connection that appears appropriate to a person skilled in the art. The driver element 20a is configured as a sleeve, in particular as a brake sleeve which cooperates with the wrap-spring element 22a in order to brake the shaft 14a. In particular, in order to generate a brake force in order to brake the shaft 14a, an external surface of the driver element 20a cooperates with an internal surface of the wrap-spring element 22a.

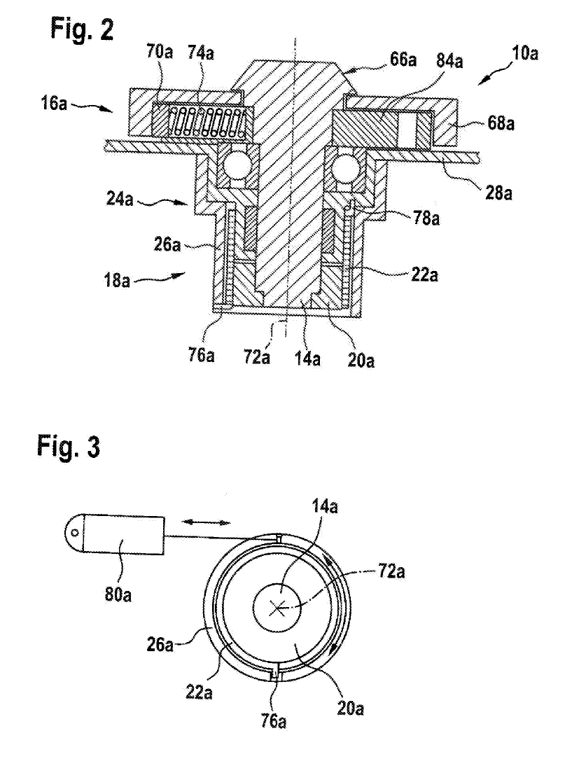

The protective device 10a furthermore comprises at least one bearing flange 28a on which the shaft 14a is rotatably mounted, wherein the wrap-spring clutch unit 18a has at least the wrap-spring element 22a, which bears against the bearing flange 28a, at least during a rotational movement of the shaft 14a, and is not in contact with the shaft 14a and/or with the driver element 20a, arranged on the shaft 14a, of the wrap-spring clutch unit 18a. The wrap-spring clutch unit 18a furthermore comprises at least one activation unit 24a which has at least one movably mounted activation element 26a which is intended, as a result of a relative movement, to bring about a winding movement of the wrap-spring element 22a of the wrap-spring clutch unit 18a. The wrap-spring clutch unit 18a comprises at least the activation unit 24a, which has at least one movably mounted activation element 26a that is mounted so as to be twistable through an angle of less than 360°. The activation element 26a is configured as an actuating sleeve. The activation element 26a is mounted so as to be twistable relative to the bearing flange 28a through an angle of less than 360° about the rotation axis 72a of the shaft 14a. The bearing flange 28a has a receiving region in which the activation element 26a is guided in a twistable manner. The activation element 26a surrounds the wrap-spring element 22a, in particular in a circumferential direction extending about the rotation axis 72a of the shaft 14 (FIG. 3). In addition, the activation element 26a surrounds the driver element 20a and the shaft 14a, in particular in the circumferential direction extending about the rotation axis 72a of the shaft 14 (FIG. 3).

One end of the wrap-spring element 22a is fixed to the bearing flange 28a. Furthermore, a further end of the wrap-spring element 22a is fixed to the activation element 26a of the activation unit 24a of the wrap-spring clutch unit 18a, said activation element 26a being twistable through less than 360°. The wrap-spring element 22a has a transverse protrusion 76a, by means of which the wrap-spring element 22a is fixed to the activation element 26a. The activation element 26a has a cutout in which the transverse protrusion 76a engages. The transverse protrusion 76a extends at least substantially perpendicularly to the rotation axis 64a of the shaft 14a. Furthermore, the wrap-spring element 22a has a longitudinal protrusion 78a, by means of which the wrap-spring element 22a is fixed to the bearing flange 28a. The bearing flange 28a has a cutout in which the longitudinal protrusion 78a engages. The longitudinal protrusion 78a extends at least substantially parallel to the rotation axis 64a of the shaft 14a. However, it is also conceivable for the wrap-spring element 22a to be fixed to the activation element 26a and/or to the bearing flange 28a in some other manner that appears appropriate to a person skilled in the art, for example by means of a screw connection, by means of a clamping connection, by means of a latching connection, or the like.

Furthermore, the activation unit 24a has at least one actuator 80a (FIG. 3), which is intended to move the activation element 26a and/or to hold it in position. Preferably, the actuator 80a is configured as a magnetic element, in particular as an electromagnet. However, it is also conceivable for the actuator 80a to have some other configuration that appears appropriate to a person skilled in the art, for example a configuration as a spring element, as an electric motor, as a linear drive element, or the like.

The wrap-spring element 22a is arranged under pretension on the bearing flange 28a and on the driver element 20a. A coil internal dimension, in particular a coil inside diameter, of the wrap-spring element 22a is smaller than a maximum external dimension, in particular an outside diameter, of the bearing flange 28a and smaller than a maximum external dimension, in particular an outside diameter, of the driver element 20a, in the region of a bearing position of the bearing flange 28a with respect to a mounting of the shaft 14a, in particular in an unloaded state of the wrap-spring element 22a. The wrap-spring element 22a bears against an external surface of the driver element 20a and against an external surface of the bearing flange 28a in a braking position of the wrap-spring element 22a, in particular in the region of the bearing position of the bearing flange 28a with respect to a mounting of the shaft 14a. Twisting of the driver element 20a relative to the bearing flange 28a in the rest state of the portable power tool 12a can advantageously be prevented. As a result of the connection for conjoint rotation between the driver element 20a and the shaft 14a, a rotational movement of the shaft 14a as a result of a force-fitting connection between the driver element 20a and the bearing flange 28a is avoidable and/or preventable. In order to enable a rotational movement of the shaft 14a, it is necessary to release the force-fitting connection between the driver element 20a and the bearing flange 28a (FIG. 3). The wrap-spring element 22a is able to be unwound in order to release the force-fitting connection between the driver element 20a and the bearing flange 28a. As a result of the wrap-spring element 22a being unwound, individual coils of the wrap-spring element 22a are movable away from the driver element 20a and the bearing flange 28a. During the unwinding of the wrap-spring element 22a, the wrap-spring element 22a, in particular individual coils of the wrap-spring element 22a, come to bear uniformly against an internal surface of the activation element 26a. It may be advantageous for brushing of the wrap-spring element 22a against the driver element 20a rotating in a machining state of the portable power tool 12a to be avoided.

The actuator 80a is intended to twist the activation element 26a and/or hold it in an enabling position in which the wrap-spring element 22a is arranged at a distance from the bearing flange 28a and from the driver element 20a by the activation element 26a. As a result of the twisting of the activation element 26a, unwinding of the wrap-spring element 22a is able to be brought about. The actuator 80a is preferably configured as a rotary magnet. When an energy supply, in particular a power supply, of the actuator 80a is interrupted, automatic twisting of the activation element 26a takes place as a result of a spring force of the wrap-spring element 22a. The wrap-spring element 22a wraps around the driver element 20a and the bearing flange 28a. The force-fitting connection between the driver element 20a and the bearing flange 28a brings about a brake force for braking the shaft 14a, which is connected to the driver element 20a for conjoint rotation. The actuator 80a can be controlled as a result of a sensor signal which is able to be generated in dependence on the occurrence of an uncontrolled blockage of the portable power tool 12a.

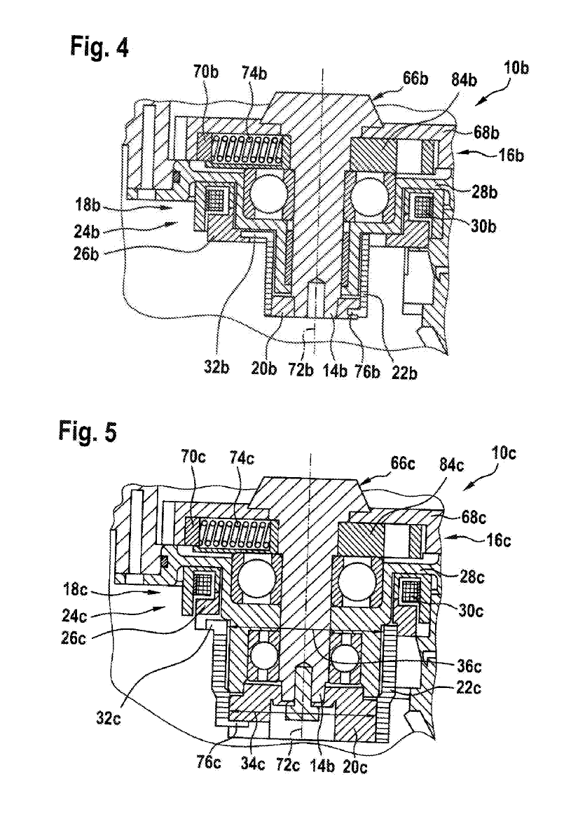

FIGS. 4 to 6 show further exemplary embodiments of the disclosure. The following descriptions and the drawing are limited substantially to the differences between the exemplary embodiments, wherein, with regard to components with identical designations, in particular with regard to components with identical reference signs, reference can also be made in principle to the drawing and/or the description of the other exemplary embodiments, in particular FIGS. 1 to 3. In order to distinguish between the exemplary embodiments, the letter a is positioned after the reference signs in the exemplary embodiment in FIGS. 1 to 3. In the exemplary embodiments in FIGS. 4 to 6, the letter a is replaced by the letters b to d.

FIG. 4 shows a sectional view of an alternative protective device 10b. The protective device 10b is intended to protect a user in the event of an uncontrolled blockage of a portable power tool (not illustrated in more detail here). The portable power tool has a configuration analogous to the portable power tool 12a described in the description given for FIGS. 1 to 3. The protective device 10b comprises at least one rotationally drivable shaft 14b and at least one wrap-spring-free overload clutch unit 16b which is arranged on the shaft 14b and is intended to interrupt transmission of a drive force if a torque limit is exceeded. The protective device 10b illustrated in FIG. 4 comprises an at least substantially analogous configuration to the protective device 10a described in the description given for FIGS. 1 to 3. In contrast to the protective device 10a described in the description given for FIGS. 1 to 3, the protective device 10b illustrated in FIG. 4 has a wrap-spring clutch unit 18b which comprises at least one wrap-spring element 22b, one end of which is fixed to a driver element 20b, connected to the shaft 14b for conjoint rotation, of the wrap-spring clutch unit 18b, and a further end of which is fixed to a rotatably mounted activation element 26b of an activation unit 24b of the wrap-spring clutch unit 18b. In FIG. 4, the wrap-spring element 22b is arranged in a rotation-enabling position, in which a rotational movement of the shaft 14b is enabled. The activation element 26b is arranged in a rotationally movable manner on the bearing flange 28b. The activation element 26b is rotatably connected to the driver element 20b via the wrap-spring element 22b. The wrap-spring element 22b is fixed to the driver element 20b by way of a transverse protrusion 76b of the wrap-spring element 22b. The wrap-spring element 22b is fixed to the activation element 26b by way of a further transverse protrusion 32b of the wrap-spring element 22b.

Furthermore, the protective device 10b comprises at least one bearing flange 28b on which the shaft 14b is rotatably mounted, wherein the activation unit 24b has at least one magnetic element 30b which, as a result of braking, brought about in particular by a magnetic force of the magnetic element 30b, of a rotational movement of the activation element 26b, is intended to produce a force fit between the bearing flange 28b and the wrap-spring element 22b. The magnetic element 30b is preferably configured as an electromagnet. However, it is also conceivable for the magnetic element 30b to have some other configuration that appears appropriate to a person skilled in the art. As a result of the magnetic element 30b being activated, the activation element 26b is attractable by a magnetic force of the magnetic element 30b. A rotational movement of the activation element 26b is brakable by an action of a magnetic force of the magnetic element 30b. As a result of a relative movement of the activation element 26b relative to the driver element 20b, said relative movement being brought about by braking of the activation element 26b, the wrap-spring element 22b is wound up. The wrap-spring element 22b is placeable against the bearing flange 28b while it is being wound up. As a result of the wrap-spring element 22b bearing thereagainst, a force-fitting connection between the driver element 20b and the bearing flange 28b is able to be produced via the wrap-spring element 22b. The driver element 20b is brakable by the force-fitting connection between the driver element 20b and bearing flange 28b. As a result of the connection for conjoint rotation between the driver element 20b and the shaft 14b, the shaft 14b is likewise brakable while the driver element 20b is being braked. With regard to further functions and features of the protective device 10b illustrated in FIG. 4, reference may be made to the protective device 10a described in the description given for FIGS. 1 to 3.

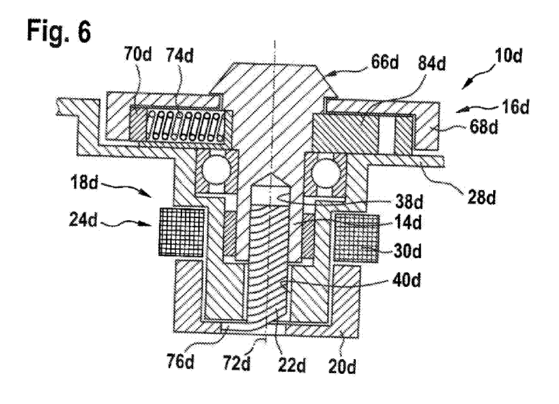

FIG. 5 shows a sectional view of a further alternative protective device 10c. The protective device 10c is intended to protect a user in the event of an uncontrolled blockage of a portable power tool (not illustrated in more detail here). The portable power tool has a configuration analogous to the portable power tool 12a described in the description given for FIGS. 1 to 3. The protective device 10c comprises at least one rotationally drivable shaft 14c and at least one wrap-spring-free overload clutch unit 16c which is arranged on the shaft 14c and is intended to interrupt transmission of a drive force if a torque limit is exceeded. The protective device 10c illustrated in FIG. 5 has an at least substantially analogous configuration to the protective device 10b described in the description given for FIG. 4. In contrast to the protective device 10b described in the description given for FIG. 4, the protective device 10c illustrated in FIG. 5 has at least one wrap-spring clutch unit 18c which comprises at least one wrap-spring element 22c which has two different coil diameters 34c, 36c. In the region of a driver element 20c of the wrap-spring clutch unit 18c, the wrap-spring element 22c has a smaller coil diameter 34c than a coil diameter 36c of the wrap-spring element 22c in the region of a bearing flange 28c of the protective device 10c. With regard to further functions and features of the protective device 10c illustrated in FIG. 5, reference may be made to the protective device 10a described in the description given for FIGS. 1 to 3 and/or to the protective device 10b described in the description given for FIG. 4.

FIG. 6 shows a sectional view of a further alternative protective device 10d. The protective device 10d is intended to protect a user in the event of an uncontrolled blockage of a portable power tool (not illustrated in more detail here). The portable power tool has a configuration analogous to the portable power tool 12a described in the description given for FIGS. 1 to 3. The protective device 10d comprises at least one rotationally drivable shaft 14d and at least one wrap-spring-free overload clutch unit 16d which is arranged on the shaft 14d and is intended to interrupt transmission of a drive force if a torque limit is exceeded. The protective device 10d illustrated in FIG. 6 has an at least substantially analogous configuration to the protective device 10a described in the description given for FIGS. 1 to 3. In contrast to the protective device 10a described in the description given for FIGS. 1 to 3, the protective device 10d illustrated in FIG. 6 has at least one wrap-spring clutch unit 18d which comprises at least one wrap-spring element 22d which is surrounded at least partially by the shaft 14d. In FIG. 6, the wrap-spring element 22d is arranged in a rotation-enabling position in which a rotational movement of the shaft 14d is enabled. The shaft 14d has an internal cutout 38d in which the wrap-spring element 22d is fixed at least by one end, in particular by means of a force-fitting connection. The wrap-spring element 22d has, in particular when considered in an unloaded state of the wrap-spring element 22d, a maximum external dimension which is greater than a maximum internal dimension of the internal cutout 38d.

Furthermore, the protective device 10d comprises at least one bearing flange 28d on which the shaft 14d is rotatably mounted, wherein the wrap-spring element 22d extends through a cutout 40d in the bearing flange 28d. The wrap-spring element 22d extends along a rotation axis 72d of the shaft 14d through the cutout 40d in the bearing flange 28d. The cutout 40d has a larger internal dimension compared with a maximum external dimension of the wrap-spring element 22d, in particular when considered in an unloaded state of the wrap-spring element 22d. The wrap-spring element 22d is fixed to a driver element 20d of the wrap-spring clutch unit 18d by a further end, in particular to an internal surface of an internal cutout in the driver element 20d. The wrap-spring element 22d is intended to connect the driver element 20d rotatably to the shaft 14d.

Furthermore, the wrap-spring clutch unit 18d has at least one magnetic element 30d which is intended to cooperate with the driver element 20d. The magnetic element 30d is preferably configured as an electromagnet. However, it is also conceivable for the magnetic element 30d to have some other configuration that appears appropriate to a person skilled in the art. As a result of the magnetic element 30d being activated, the driver element 20d is attractable by a magnetic force of the magnetic element 30d. The driver element 20d forms an activation element of an activation unit 24d of the wrap-spring clutch unit 18d. A rotational movement of the driver element 20d is brakable by an action of a magnetic force of the magnetic element 30d. As a result of a relative movement of the driver element 20d relative to the bearing flange 28d and to the shaft 14d, said relative movement being brought about by the driver element 20d being braked, the wrap-spring element 22d is unwound. The wrap-spring element 22d is placeable against an internal surface of the cutout 40d in the bearing flange 28d as a result of unwinding. As a result of the wrap-spring element 22d bearing against the internal surface of the cutout 40d in the bearing flange 28d, a force-fitting connection between the shaft 14d and the bearing flange 28d is able to be produced via the wrap-spring element 22d. The shaft 14d is brakable by the force-fitting connection between the shaft 14d and the bearing flange 28d. With regard to further functions and features of the protective device 10d illustrated in FIG. 6, reference may be made to the protective device 10a described in the description given for FIGS. 1 to 3.

What is claimed is:

1. A protective device at least for protecting a user in the event of an uncontrolled blockage of a portable power tool, comprising:
at least one rotationally drivable shaft;
at least one wrap-spring-free overload clutch unit which is arranged on the shaft and is configured at least to interrupt transmission of a drive force if a torque limit is exceeded; and
at least one wrap-spring clutch unit configured to brake the shaft.

2. The protective device according to claim 1, wherein the wrap-spring clutch unit comprises:
at least one driver element connected to a free end of the shaft; and
at least one wrap-spring element configured to cooperate with the driver element in order to brake the shaft.

3. The protective device according to claim 2, wherein the driver element is connected to the shaft for conjoint rotation.

4. The protective device according to claim 1, wherein the wrap-spring clutch unit comprises:
at least one activation unit including at least one movably mounted activation element configured to bring about a winding movement of a wrap-spring element of the wrap-spring clutch unit as a result of a relative movement.

5. The protective device according to claim 1, wherein the wrap-spring clutch unit comprises:
at least one activation unit which has at least one movably mounted activation element that is mounted so as to be twistable through an angle of less than 360°.

6. The protective device according to claim 1, further comprising:
at least one bearing flange on which the shaft is rotatably mounted,
wherein the wrap-spring clutch unit has at least one wrap-spring element which bears against the bearing flange at least during a rotational movement of the shaft and is not in contact with the shaft or with a driver element, arranged on the shaft, of the wrap-spring clutch unit.

7. The protective device according to claim 6, wherein:
one end of the wrap-spring element is fixed to the bearing flange and another end is fixed to an activation element of an activation unit of the wrap-spring clutch unit, and
the activation element is twistable through less than 360°.

8. The protective device according to claim 1, wherein the wrap-spring clutch unit comprises:
at least one wrap-spring element, one end of which is fixed to a driver element of the wrap-spring clutch unit, the driver element being connected to the shaft for conjoint rotation, and the other end of which is fixed to a rotatably mounted activation element of an activation unit of the wrap-spring clutch unit.

9. The protective device according to claim 8, further comprising:
at least one bearing flange on which the shaft is rotatably mounted,
wherein the activation unit has at least one magnetic element which is configured to produce a force fit between the bearing flange and the wrap-spring element as a result of a rotational movement of the activation element being braked.

10. The protective device according to claim 1, wherein the wrap-spring clutch unit comprises:
at least one wrap-spring element having two different coil diameters.

11. The protective device according to claim 1, wherein the wrap-spring clutch unit comprises:
at least one wrap-spring element which is surrounded at least partially by the shaft.

12. The protective device according to claim 11, wherein the shaft has an internal cutout in which the wrap-spring element is fixed at least with one end.

13. The protective device according to claim 11, further comprising:
at least one bearing flange on which the shaft is rotatably mounted,
wherein the wrap-spring element extends through a cutout in the bearing flange.

14. The protective device according to claim 1, wherein the wrap-spring clutch unit is arranged at an end of the shaft which is remote from a further end of the shaft at which the overload clutch unit is arranged.

15. A portable power tool, comprising:
at least one percussion mechanism unit; and
at least one protective device configured to protect a user in the event of an uncontrolled blockage of the portable power tool, the protective device including (i) at least one rotationally drivable shaft, (ii) at least one wrap-spring-free overload clutch unit which is arranged on the shaft and is configured at least to interrupt transmission of a drive force if a torque limit is exceeded, and (iii) at least one wrap-spring clutch unit configured to brake the shaft.

16. The portable power tool of claim 15, wherein the portable power tool is a hammer drill or a chipping hammer.
